(19) United States
(12) Patent Application Publication
(10) Pub. No.: US 2005/0278966 A1
(43) Pub. Date: Dec. 22, 2005

(54) Laser level

(76) Inventor: Carl Y. Liu, Nanjing City (CN)

Correspondence Address: WALLENSTEIN WAGNER & ROCKEY, LTD, 311 SOUTH WACKER DRIVE, 53RD FLOOR, CHICAGO, IL, 60606, US

(21) Appl. No.: 11/004,342

(22) Filed: Dec. 3, 2004

(30) Foreign Application Priority Data
Jun. 18, 2004 (CN) 200420028106.4

(51) Int. Cl. G01C 15/00

(52) U.S. Cl. 33/286

(57) ABSTRACT

A laser level is provided to generate a laser beam. The laser level has a main body and a removable pedestal. The main body includes a housing, at least one laser generator, a power source and a switch. The pedestal and the main body mount to each other by magnetism, and the pedestal has a spherical or similar slippery upper surface, the main body has a base surface with a corresponding matching shape such that the main body and the pedestal can well inosculate to each other. The main body can be swiveled or moved all around on the pedestal, and laser beams of different angles and directions can be formed thereby.

### CROSS-REFERENCE TO RELATED APPLICATIONS

This application claims priority from Chinese Application No. 200420028106.4, filed on Jun. 18, 2004.

### FEDERALLY SPONSORED RESEARCH OR DEVELOPMENT

Not Applicable.

### TECHNICAL FIELD

The present invention relates to a laser leveling device which reflects at least one line on a surface as a positioning reference, and more particularly to a laser level which marks at least one movable and rotatable line on a reference surface for indication.

### BACKGROUND OF THE INVENTION

There are many kinds of laser leveling devices. One such device is disclosed by U.S. Pat. No. 6,735,879, which can project a planar laser beam and define a visible line of fixed orientation on a surface. Other laser leveling devices are marketed in the United States by CST/Berger Co., Zircon Co., and others. Some of those laser leveling devices can only project fixed horizontal or perpendicular laser beams, others can be adjusted by hand thereby to project adjustable beams, and others are self-leveling. These conventional laser leveling devices may have their respective advantages, but when in practical use, deficiencies will come to light. For example, a device with a fixed laser beam often requires a flat support surface and can not attain precise indication on a rough or oblique surface. Additionally, while self-leveling laser devices commonly comprise plumb means to project horizontal or perpendicular laser beams, and usually can't project laser beams of other angles. Furthermore, their self-leveling ability is always limited by the tilting angle of the surface they seated on. Even those hand-adjustable laser leveling devices have disadvantages. For example, some can only adjust the angle of the laser beams, others only can translate the laser beams without rotating. Thus, while laser leveling devices according to the prior art provide a number of advantageous features, they nevertheless have certain limitations. The present invention seeks to overcome certain of these limitations and other drawbacks of the prior art, and to provide new features not heretofore available.

### SUMMARY OF THE INVENTION

The present invention provides a laser level with a main body which can be rotated and moved on a removable pedestal thereby to alter the locational relationship of the laser beam projected from the main body with the base plane of the pedestal of the laser level.

According to one embodiment, the laser level includes a main body and a removable pedestal. The main body includes a housing, at least one laser generator, a power for the laser generator and a switch. The pedestal and the main body mount to each other by magnetism. The pedestal has a spherical or similar slippery upper surface, and the main body portion has a base surface with corresponding matching shape such that the main body and the pedestal can well inosculate to each other thereby to form a spherical or similar contact area.

According to another embodiment, the removable pedestal can comprise at least one push button with at least one retractable pin for positioning the laser level on a wooden, plastic or other soft object.

According to another embodiment, the laser level can further comprise two leveling indication means which are vertical to each other for indicating a precise horizontal line or plumb line. The laser level may also comprise a third leveling indication means vertical to both of the former two.

The laser level of the present invention is simple in structure, less costly, and expedient for marking a reference line on a workpiece as needed. It is appreciated that the main body can be swiveled or moved on the pedestal, and reference lines of different angular degrees and orientations can be formed thereby without rotating or moving the pedestal.

Other features and advantages of the invention will be apparent from the following examples in the specification taken in conjunction with the following drawings.

### BRIEF DESCRIPTION OF THE DRAWINGS

To understand the present invention, it will now be described by way of example, with reference to the accompanying drawings in which:

FIG. 1 illustrates a front view of one embodiment of a laser level with the left clamshell housing of the main body cut away;

FIG. 2 is an inner perspective view of the laser level of FIG. 1;

FIG. 3 is a perspective view of the removable pedestal;

FIG. 4 is a perspective view of the laser level with the pins protruding outwardly from the removable pedestal;

FIG. 5 illustrates another perspective view of the laser level with the battery cover thereon;

FIG. 6 is a perspective view of the laser level with three leveling indication means;

FIG. 7 is a perspective view of the laser level of the FIG. 6 with a fan-shaped laser beam when it is positioned and held on a wall; and,

FIG. 8 is a perspective view of a laser level projecting and defining a reference line on a wall, and rotating the main body to another orientation thereby defining another reference line.

### DETAILED DESCRIPTION

While this invention is susceptible of embodiment in many different forms, and will herein be described in detail, preferred embodiments of the invention are disclosed with the understanding that the present disclosure is to be considered as exemplifications of the principles of the invention and are not intended to limit the broad aspects of the invention to the embodiments illustrated.

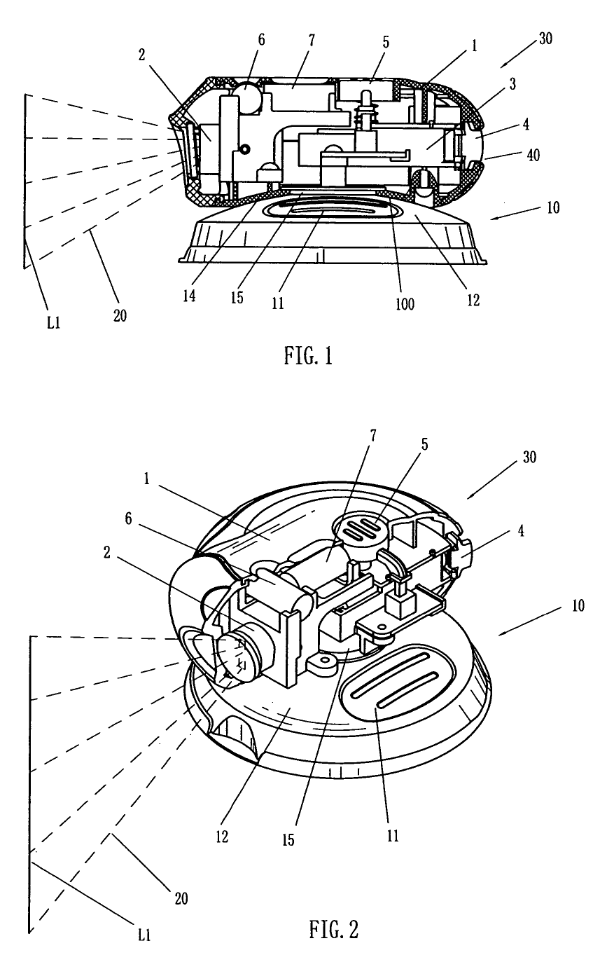

Referring to FIGS. 1 and 2, one embodiment of the laser level comprises a main body 30 and a removable pedestal 10, wherein the main body 30 includes a housing 1, a laser generator 2 which is contained and fixed in the housing 1, a switch 5, a battery pack or power source 8, and a container 3 for receiving the battery pack 8. When the switch 5 is triggered on, the laser generator 2 is electrically connected to the battery pack 8 and a fan-shaped laser beam 20 is then projected on an object surface thereby to form a visible laser line L1. A general laser leveling device with a laser generator for generating a fan-shaped laser beam is well known in the art. Persons skilled in the art will recognize that the device shown in the drawings is not the only embodiment. The laser level of the present invention may also comprise two or more laser generators.

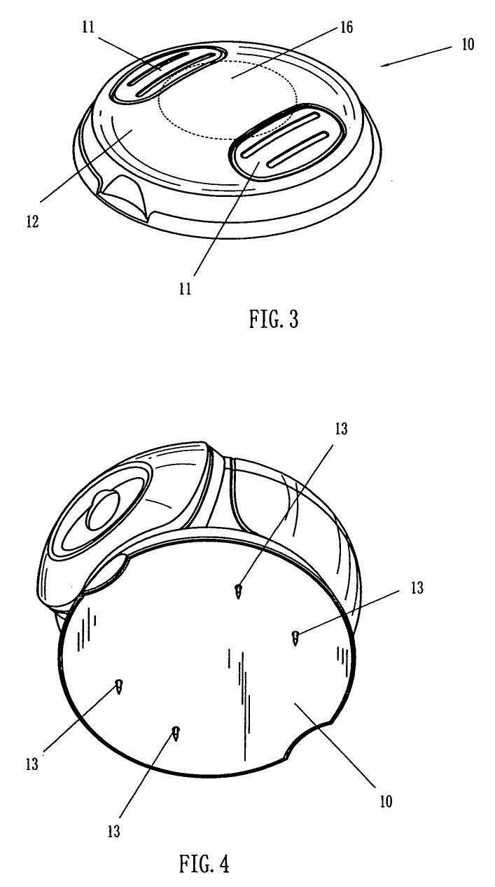

Referring to FIGS. 1 and 3, the pedestal 10 has a spherical or similar slippery upper surface 12. Further, the main body 30 has a base surface 14 with corresponding matching shape such that the main body 30 and the pedestal 10 can well inosculate to each other thereby to form a spherical or similar contact area 100. Persons skilled in the art will recognize that the base surface of the main body and the upper surface of the pedestal are not limited merely to the examples shown in the drawings. In an alternate embodiment the upper surface of the pedestal can be a spherical or similar concave, not shown, and the base surface of the main body may have a convexity with a corresponding matching shape such that the two component part of the laser level will inosculate to each other to form a concave contact area.

The pedestal 10 and the main body 30 mount to each other by magnetism. Referring to FIGS. 1 and 3, a magnetic member 15 is arranged near the bottom of the main body 30, and a metallic or magnetic attracting member 16 is fixed in the pedestal 10 for removably attaching the pedestal 10 to the main body 30. Obviously, the magnetic member 15 can be alternatively arranged in the pedestal 10 and the attracting member 16 can be arranged in the main body 30. The magnetism should be strong enough so that substantially no movement be taken between the main body and the pedestal without any aid of foreign force on any position.

Referring to FIGS. 1 and 2, one embodiment of the laser level preferably has a first leveling indication means 6 and a second leveling indication means 7 which are vertical to each other and respectively perpendicular or horizontal to the plane of the laser beam 20. The laser level may also comprise a third leveling indication means 9 vertical to both of the former two, as shown in FIG. 6. The three leveling indicators 6, 7, and 9 can be three conventional water columns with level bubbles 17 therein for orientation or leveling a precise horizontal or plumb line by rotating or moving the main body 30 upon the pedestal 10.

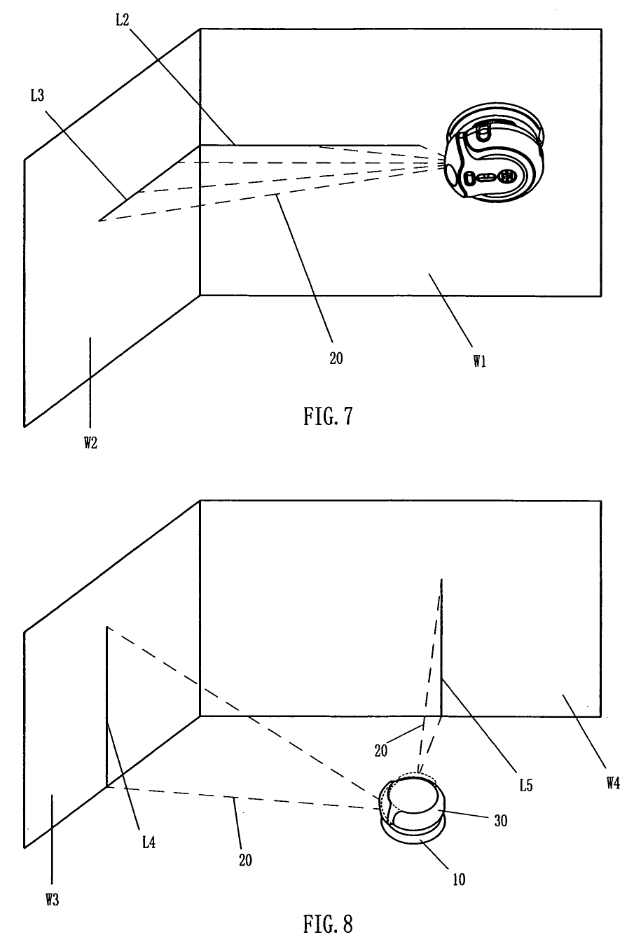

When laser level is disposed on a horizontal plane as shown in FIGS. 1 and 2, moving the main body 30 on the pedestal 10 until the bubble 17 of the first leveling indication means 6 slides to the center of the column will allow the laser generator 2 to emit a laser beam 20 that contacts a wall and forms a vertical line L1 thereby. Referring to FIG. 7, when laser level is disposed against a wall W1, moving the main body 30 on the pedestal 10 until the bubble 17 of the second leveling indication means 7 slides to the center of the column allows the laser generator 2 to emit a laser beam 20 that contacts the wall W1 and forms a horizontal line L2 thereby. Moving the main body 30 until the bubble 17 of the third leveling indication means 9 slides to the center of the column will allow a horizontal line L3 to be formed on the opposite wall W2.

One embodiment of the laser level can also achieve laser beams of various orientations without moving or rotating the pedestal 10, and instead by rotating the main body 30 on the pedestal 10. Referring to FIG. 8, the laser level emits a laser beam 20 and forms a laser line L4 on a wall W3. If needed, the main body 30 can be rotated on the pedestal 10 to another position, shown as dotted line, whereby the laser beam 20 contacts the wall W4 and forms another laser line L5.

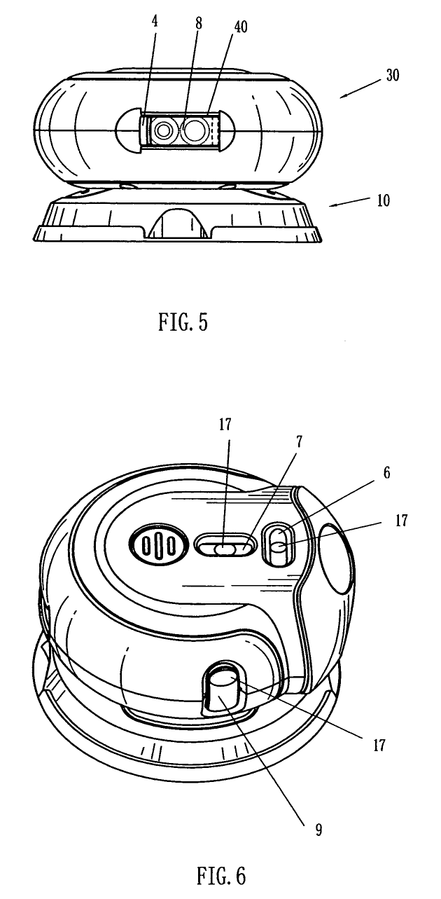

Referring to FIGS. 1 and 5, an entrance 40 for the battery pack 8 in the housing 1 and a battery cover 4 which is slideable in the present embodiment is shown.

As shown in FIG. 3, the pedestal 10 may comprise at least one push button 11 which connects with at least one retractable pin 13 for positioning the laser level on a wooden, plastic or other soft object as desired. When not in use, the pins 13 can retract into the pedestal 10. FIG. 4 is a perspective view of an embodiment of a laser level with four pins 13 protruding outwardly from the removable pedestal 10.

As described hereinabove, when in practical use of a laser level of the present invention, the pedestal may be positioned on a floor, a wall or the surface of an object, and the main body may be attached to the pedestal thereafter. Because of the spherical shape of the contact area, the main body can be swiveled or moved to define laser beams of different orientation and angular degrees within a certain range. Horizontal or vertical lines will be attained with reference to leveling indication means.

Several alternative embodiments and examples have been described and illustrated herein. A person of ordinary skilled in the art would appreciate the features of the individual embodiments, and the possible combinations and variations of the components. A person of ordinary skill in the art would further appreciate that any of the embodiments could be provided in any combination with the other embodiments disclosed herein. Additionally, the terms “first,” “second,” and “third” as used herein are intended for illustrative purposes only and do not limit the embodiments in any way. Further, the term “plurality” as used herein indicates any number greater than one, either disjunctively or conjunctively, as necessary, up to an infinite number.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

1. A laser level, comprising:
a main body comprising a housing, at least one laser generator in the housing, a power source, and a switch electrically connected to the power source; and,
a pedestal;
wherein one of the main body or the pedestal has one of a concave or a convex contact area and the other of the main body or the pedestal has a mating concave or convex contact area to removably attach the main body to the pedestal.

2. The laser level of claim 1, wherein the pedestal has a spherical or similar upper surface, and wherein the main body has a base surface with a corresponding mating shape.

3. The laser level of claim 1, wherein the pedestal and the main body removably attach to each other by magnetism.

4. The laser level of claim 1, further comprising a magnetic member associated with one of the main body or the pedestal, and a corresponding attracting member in the other of the main body or the pedestal.

5. The laser level of claim 1, wherein the pedestal comprises at least one push button connected to at least one retractable pin.

6. The laser level of claim 1, wherein the main body comprises at least one leveling indicator.

7. The laser level of claim 6, further comprising a first leveling indicator and a second leveling indicator on the main body, the second leveling indicator being perpendicular to the first leveling indicator.

8. The laser level of claim 7, further comprising a third leveling indicator on the main body, the third leveling indicator being vertical to the first and second leveling indicators.

9. A laser level, comprising:
a main body comprising a housing, at least one laser generator in the housing, a power source, and a switch electrically connected to the power source; and,
a pedestal;
wherein the main body is removably attachable to the pedestal in a plurality of locations on the pedestal.

10. The laser level of claim 9, wherein the main body is moveable in a plurality of directions on the pedestal.

11. The laser level of claim 9, wherein the main body is moveable under force in a plurality of directions when the main body is attached to the pedestal.

12. The laser level of claim 9, wherein the one of the main body or the pedestal has one of a concave or a convex contact area and the other of the main body or the pedestal has a mating concave or convex contact area to removably attach the main body to the pedestal.

13. A laser level, comprising:
a main body comprising a housing, at least one laser generator in the housing to project a laser beam, a power source, and a switch electrically connected to the power source; and,
a pedestal;
wherein the main body can be removably swiveled and moved on the pedestal to alter the locational position of the laser beam projected from the laser generator in the main body with a base plane of the pedestal of the main body.

14. The laser level of claim 13, wherein the laser beam can be spatially adjusted by moving the relationship of the main body and the pedestal.

15. The laser level of claim 13, wherein one of the main body or the pedestal has one of a concave or a convex contact area and the other of the main body or the pedestal has a mating concave or convex contact area to removably attach the main body to the pedestal.

16. The laser level of claim 13, wherein the pedestal has a spherical or similar upper surface, and wherein the main body has a base surface with a corresponding mating shape.

17. The laser level of claim 13, wherein the pedestal and the main body removably attach to each other by magnetism.

18. A laser level, comprising:
a main body comprising a housing, at least one laser generator in the housing, the laser generator projecting a fan-shaped laser beam, a power source for the laser generator, and a switch electrically connected to the power source, the housing having a base surface having one of a convex or a concave portion; and,
a pedestal having an upper surface that has a mating convex or concave portion to mate with the corresponding convex or concave portion of the base surface of the main body.

19. The laser level of claim 18, wherein the laser beam can be spatially adjusted by moving the main body on the pedestal.

20. A laser device, comprising:
a main body comprising a housing, a laser generator positioned within the housing, a power source for the laser generator to project at least one laser beam, and a switch electrically connected to the power source and the laser generator; and,
a pedestal, wherein the main body and the pedestal attach to each other at a spherical contact area such that the laser beam can be spatially adjusted.
